(19) United States
(12) Patent Application Publication
(10) Pub. No.: US 2014/0329014 A1
(43) Pub. Date: Nov. 6, 2014

(54) Composition and Method for Treating Wood

(71) Applicant: DanIP Pty Ltd, Pelican Waters (AU)

(72) Inventor: Peter Raynor Soundy Cobham, Pelican Waters (AU)

(73) Assignee: DanIP Pty Ltd, Pelican Waters (AU)

(21) Appl. No.: 14/268,781

(22) Filed: May 2, 2014

(30) Foreign Application Priority Data
May 3, 2013 (AU) 1013901555

(51) Int. Cl. A01N 25/04; B27K 3/02

(52) U.S. Cl. CPC A01N 25/04; B27K 3/0285
USPC 427/297; 514/499

(57) ABSTRACT

The present invention relates to a composition for treating wood comprising a wood preserving compound and a carrier, wherein the carrier is an emulsion comprising a hydrophobic phase, a hydrophilic phase and a surfactant system. In particular, the surfactant system comprises a non-ionic polyethoxylated alkyl amine and an anionic C₁₀-C₁₆ alkylbenzene sulfonate. Methods of using the composition to treat wood, especially timber, are also described.

### RELATED APPLICATION

This application claims priority under 35 U.S.C. §119 to Australian Application No. 2013901555, filed May 3, 2013. The entire teaching of the above application is incorporated herein by reference.

### FIELD OF THE INVENTION

The present invention relates to a composition for treating wood comprising a wood preserving compound and a carrier, wherein the carrier is an emulsion comprising a hydrophobic phase, a hydrophilic phase and a surfactant system. In particular, the surfactant system comprises a non-ionic polyethoxylated alkyl amine and an anionic C₁₀-C₁₆ alkylbenzene sulfonate. Methods of using the composition to treat wood, especially timber, are also described.

### BACKGROUND OF THE INVENTION

Wood is a common commodity used in home building (frames and trusses), for exterior above ground construction (fencing, gazebos, trellising), indoor use (furniture, floors), and for in ground use (farm fencing, vineyard trellising, utility poles). Wood is also utilised in marine environments (piling). Apart from naturally durable woods, all these applications require chemical protection of the wood from fungal, bacterial and insect attack.

Standards for wood protection have been developed either on a country or regional basis. These standards are subdivided into hazard classes or on a commodity basis. In the case of the commodity standards (American wood Preservers Association) the standards refer back to the biological hazards involved.

Hazard class standards are divided into either 5 or 6 classes. The difference being the way the in ground hazard class is dealt with to allow for the higher hazard associated with utility poles.

Hazard Class 1: Insect Attack; wood in internal situation protected from weather.

Hazard Class 2: Termite Attack; wood in internal situation protected from weather.

Hazard Class 3: Fungal, insect and termite attack; wood in external situation above ground but subject to wetting.

Hazard Class 4/5: Fungal, bacterial, insect and termite attack; wood in ground, subject to wetting.

Hazard Class 5/6: Marine organisms, fungal, bacterial, insect and termite attack in a fresh water or marine environment.

For each Hazard Class, the standards define penetration of the wood commodity required by preservative treatment. For example, Hazard Class 3 and above will normally require at least full sapwood penetration of the preservative chemical, whereas envelope treatments are acceptable for insect and termite protection in Hazard Classes 1 and 2.

Preservatives appropriate for each hazard class are also defined in various country standards, for example, the Australian and New Zealand standards are AS1604 and NZS3640 respectively.

The wood preservative may be included in a composition containing a carrier. Carriers range from water, through emulsions to non-aqueous carriers such as solvents or oils.

Treatment methods include dipping, spraying and brushing for superficial and envelope treatments or vacuum pressure treatment where deeper penetration of the wood preservative is required.

Wood treated with aqueous preservative compositions increase the water content of the wood and cause swelling. A typical water-borne treatment has an uptake of 300 to 600 L/m³. These treatments are often referred to as providing “wet after” wood. Wet after wood will dry in service down to provide an equilibrium moisture content. In Australia and New Zealand, typical equilibrium moisture content is 15-18%. The drying of the wet after wood will subject the wood to shrinkage and checking which can affect the appearance of the timber. Furthermore, swelling or shrinkage in a wall frame or truss can lead to both structural and cosmetic defects in a building.

Non-aqueous formulations, such as Light Organic Solvent Preservatives (LOSP), provide timber that can be supplied at a moisture content equivalent to the equilibrium moisture content and are often referred to as providing “dry after” wood. A typical LOSP treatment has an uptake ranging from 30 to 50 L/m³. Unlike aqueous formulations, non-aqueous formulations do not swell the wood. However, non-aqueous formulations often contain high levels of volatile organic chemicals (VOCs) that can result in release of “greenhouse gasses” and odour being associated with the treated timber. Some non-aqueous formulations although initially assisting in penetration of the preserving agent into the wood can subsequently cause the preserving agent to bleed to the surface of the wood where it is then lost. Non-aqueous treatments, although not swelling the treated wood, are significantly more expensive than aqueous treatments.

“Dry after” wood can also be achieved by redrying wood that has been water-borne treated but this is expensive and can result in timber degradation due to splitting and dimensional movement.

Some aqueous/glycol formulations can be used to form envelopes and for deeper sapwood penetration of the wood preservative. However, these compositions are fundamentally polar and result in swelling of the wood. Glycol formulations may cause permanent swelling of the wood as these formulations are hydroscopic and therefore attract water into the wood.

Emulsions have been used to deliver preservative compounds into wood. However, emulsions tend to be unstable and may separate into hydrophobic phase and hydrophilic phase before or during use in treating wood.

Furthermore, emulsions are currently used in wood preservation where one or more of the active compounds is not water soluble. These active compounds are solubilised in non-aqueous solvent which is mixed with an aqueous solvent to form an emulsion. In these cases, the ratio of non-aqueous to aqueous phase is very low. The non-aqueous phase is generally present in an amount of less than 5% of the emulsion composition.

Another difficulty with emulsion compositions is that a “mayonnaise” type formulation may form which, although reducing uptake of moisture content, prevents or reduces penetration of the preservative compound and therefore results in very low uptakes of preservative which may not meet required standards.

Although emulsions can be used to deliver preservative compounds into wood, high water content in emulsions can result in high water uptake and therefore “wet after” wood and high water content can also reduce the uptake and penetration of the preservative compound. Penetration of the preservative compound is usually increased with increasing the proportion of hydrophobic phase.

There is a need for new wood preserving formulations that have the required stability and allow the desired level of penetration of the preservative compound, while reducing the use of organic solvents or oils in the formulation to provide an economic and environmentally friendly treatment.

### SUMMARY OF THE INVENTION

The present invention is predicated in part on the discovery that stable emulsions useful as carriers for preservative compounds, can be formed in the presence of a surfactant system comprising a non-ionic polyethoxylated alkyl amine and an anionic C₁₀-C₁₆ alkyl benzene sulfonate. Stability of the emulsion and penetration of the preservative compound into the wood to be treated may be further improved by the addition of a tertiary or quaternary ammonium salt to the surfactant system.

In a first aspect of the invention there is provided a composition for treating wood comprising a carrier and at least one wood preserving compound; said carrier being an emulsion comprising:

(i) a hydrophobic phase;

(ii) a hydrophilic phase; and

(iii) a surfactant system comprising:

(iv) a non-ionic polyethoxylated alkyl amine and

(v) an anionic C₁₀-C₁₆alkyl benzene sulfonate.

In some embodiments, the composition further comprises a quaternary ammonium salt, such as benzylalkonium chloride or dodecyldimethyl ammonium chloride.

In another aspect of the present invention there is provided a method of treating wood comprising the steps of:

(i) providing wood for treatment; and

(ii) contacting the wood with a composition of the invention.

In some embodiments, the wood is contacted with the composition by dipping, spraying or brushing to provide a superficial or envelope treatment. In other embodiments, the wood is contacted with the composition using a vacuum pressure process, especially a Lowry or Reuping process, to provide full sapwood penetration at the lowest possible uptake (L/m³) of composition.

### DESCRIPTION OF THE INVENTION

The present invention seeks to reduce the cost and environmental impact of a carrier used in the treatment of wood by reducing the amount of non-polar solvent used, while maintaining the effectiveness of the treatment, including emulsion stability, penetration of the wood preservative and minimising the swelling or wetness of the wood after treatment. The present invention provides an alternative wood preserving composition and methods compared to those currently available.

The articles “a” and “an” are used herein to refer to one or to more than one (i.e. to at least one) of the grammatical object of the article. By way of example, “an element” means one element or more than one element.

As used herein, the term “about” refers to a quantity, level, value, dimension, size, or amount that varies by as much as 30%, 25%, 20%, 15% or 10% to a reference quantity, level, value, dimension, size, or amount.

Throughout this specification, unless the context requires otherwise, the words “comprise”, “comprises” and “comprising” will be understood to imply the inclusion of a stated step or element or group of steps or elements but not the exclusion of any other step or element or group of steps or elements.

In a first aspect of the invention there is provided a composition for treating wood comprising a carrier and at least one wood preserving compound; said carrier being an emulsion comprising:

(i) a hydrophobic phase;

(ii) a hydrophilic phase; and

(iii) a surfactant system comprising:
(a) a non-ionic polyethoxylated alkyl amine and
(b) an anionic C₁₀-C₁₆alkyl benzene sulfonate.

A wide variety of wood preserving compounds may be included in the composition of the invention. Oil soluble preservative compounds are contained in the hydrophobic or non-polar phase of the emulsion carrier and water soluble preservatives are contained in the hydrophilic or polar phase of the emulsion carrier. The preservative compound may be any compound that may be used to protect wood from biological organisms. For example, the preservative may be a fungicide, bactericide or insecticide such as a termiticide. Suitable insecticides and termiticides include synthetic pyrethroids such as permethrin, cypermethryn, deltamethrin, and bifenthrin and neonicotinoids such as imidichloprid and thiochloprid. Suitable fungicides and mouldicides include creosote, pentachlorophenol (PCP), azoles such as tebcuconazole, propiconazole, cyperconazole and the like; organic copper compounds such as copper 8-quinolinolate, copper naphthenate, copper octanoate and bis-(N-cyclohexyldiazeniumdioxy)copper (Cu-HDO), organic zinc compounds such as zinc naphthenate, organic tin compounds such as tributyl-tin naphthenate (TBTN); silver compounds, iodopropynyl-butylcarbamate (IPBC), 3-benzothien-2-yl-5,6,dihydro-1,4,2-oxathiazine-4-oxide (Bethoguard®), quaternary ammonium compounds, tertiary ammonium compounds and isothiazalones and boron compounds. The preservatives may also be a micronised or dispersed active such as copper carbonate, copper oxide, or oxine copper. These water based copper compounds are generally used in combination with at least one other co-biocide, for example, azoles with or without an insecticide such as a synthetic pyrethroid.

In some embodiments, the composition may comprise a mixture of preservatives. For example, fungicides such as propiconizole and tebuconizole may be used together especially in a 1:1 ratio. Suitable amounts of these compounds may achieve a timber loading of 0.03% mass/mass for each compound. In other embodiments, the composition may contain fungicides and insecticides such as termiticides. For example, a combination of propiconizole and tebuconizole may be combined with a pyrethroid such as bifenthrin or permethrin. Suitable ratios would be 1 (propiconizole):1 (tebuconizole):0.67 (permethrin) or 0.16 (bifenthrin). A suitable combination would be propiconizole and permethrin or bifenthrin. A person skilled in the art could determine suitable amounts of fungicides or insecticides to use in a mixture to achieve a desired % mass/mass loading in the timber product.

In some embodiments, the wood preserving compound is solubilised in the hydrophobic phase or hydrophilic phase. In other embodiments, the wood preserving compound may be encapsulated and solubilised or suspended in the hydrophobic or hydrophilic phase. Encapsulation may be particularly useful if the preservative is toxic to humans, heat unstable and/or chemically unstable in water or oil or if a slow release of the preservative is required. Microencapsulation of the preservative may be achieved by methods known in the art, such as pan coating, air-suspension coating, centrifugal extrusion, vibration nozzle encapsulation, spray drying, interfacial polymerization, in-situ polymerisation and matrix polymerisation.

The amount of preservative present in the composition is dependent on the type of preservative used and the loading required. A person skilled in the art could readily determine a suitable amount of preservative. In general, the preservative will be included in an amount of below 10% of the composition, especially below 5% of the composition, more especially below 2% of the composition.

The hydrophobic phase of the emulsion may also be referred to as the non-polar phase herein. The hydrophobic phase may be any liquid that is immiscible with the hydrophilic phase of the emulsion. The term “immiscible” as used in relation to the hydrophobic phase refers to the hydrophobic phase has no more than 30% solubility in the hydrophilic phase, especially no more than 20%, solubility and more especially no more than 10% solubility in the hydrophilic phase. In particular embodiments, the hydrophobic phase has less than 10% or 5% solubility in the hydrophilic phase. Suitable hydrophobic phases include oils and non-polar solvents and may be considered a flammable oil or solvent or a combustible oil or solvent.

Flammable oils or solvents have a flash point ≦61° C. Suitable flammable oils and solvents include white spirits (including low odour/low aromatic white spirits), mineral spirits, Stoddards solvent (hydrocarbons, typically greater than 65% C₁₀ or higher hydrocarbons), kerosene, turpentines, jet fuel, low flash point hydrocarbons including those treated to remove or reduce aromatic hydrocarbons such as Exxsol™ D30 and Exxsol™ D40, low flash point bio-solvents and the like. White spirits are typically a mixture of aliphatic and alicyclic C₇-C₁₂ hydrocarbons with a minimum content of about 25% of C₇-C₁₂ aromatic hydrocarbons. Mineral spirits typically is a mixture of hydrocarbons with 65% or greater C₁₀ hydrocarbons, hexane and a maximum benzene content of 1% v/v.

Combustible oils or solvents have a flash point of >61° C. Suitable combustible oils and solvents include mineral oils, vegetable oils, fish oils, biodiesel, aromatic solvents, low aromatic hydrocarbon solvents, diesel, aromatic oil and mixtures thereof. The biodiesel may be sourced from edible or non-edible sources including vegetable oils, animal fat or alcohol. Suitable aromatic solvents include naphthalene and indene and aromatic oil is a mixture of naphthalene, 3a,4,7,7a-tetrahydro-4,7-methanoindene and optionally indene. Suitable low aromatic hydrocarbon solvents include those such as Exxsol™ D60, Exxsol™ D80, Exxsol™ D100, Exxsol™ D120 and Exxsol™ D140. Other suitable combustible oils or solvents include paraffin oil, isoparaffin oil, such as Isopar L, M or V, narrow cut kerosene and high flash kerosene.

The hydrophilic phase of the emulsion may also be referred to as the polar phase herein. The hydrophilic phase may be any liquid that is immiscible with the hydrophobic phase of the emulsion. The term “immiscible” as used in relation to the hydrophilic phase refers to the hydrophilic phase has no more than 30% solubility in the hydrophobic phase, especially no more than 20%, solubility and more especially no more than 10% solubility in the hydrophobic phase. In particular embodiments, the hydrophilic phase has less than 10% or 5% solubility in the hydrophobic phase. Suitable hydrophilic phases include water, monoethylene glycol, polyethylene glycol, hexylene glycol, glycerine, acetone and alcohols (both flammable and combustible) such as methanol, ethanol and isopropanol, or mixtures of such hydrophilic solvents.

The hydrophobic phase and hydrophilic phase content is provided as a ratio of hydrophobic phase and hydrophilic phase in the emulsion. The hydrophilic phase is present in an amount greater than 10% up to 95% v/v of the mixture of hydrophobic phase and hydrophilic phase. The oil is present in an amount from 5% to less than 90% v/v of the mixture of hydrophobic phase and hydrophilic phase. In some embodiments, the ratio of water is 20% up to 80% v/v or 30 to 70% v/v. In these embodiments, the ratio of hydrophobic phase in the emulsion is 20% to 80% or 30 to 70% v/v. In some embodiments, the ratio of hydrophobic phase to hydrophilic phase is selected from 80:20, 70:30, 60:40, 50:50, 40:60, 30:70 and 20:80. The emulsion may be an oil-in-water emulsion or a water-in-oil emulsion depending on the ratio of hydrophilic and hydrophobic phases.

The emulsion composition also includes a surfactant system comprising a non-ionic polyethoxylated alkyl amine and an anionic C₁₀-C₁₆ alkylbenzene sulfonate.

A polyethoxylated alkyl amine is a compound having the structure:

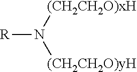

wherein R is a C₁₀ to C₂₀ linear or branched alkyl group or a C₁₀ to C₂₀ linear or branched alkenyl group and x and y are independently selected from 1 to 15.

In some embodiments, R is a linear alkyl group selected from C₁₂-alkyl (lauryl), C₁₄-alkyl (myristyl), C₁₆ alkyl (palmityl) and C₁₈ alkyl (steryl) or a linear alkenyl group selected from C₁₆ alkenyl (palmitolyl) or C₁₈ alkenyl (oleyl, linolyl, linolenyl). In particular embodiments, R is a C₁₈ alkenyl group, especially a monounsaturated C₁₈ alkenyl group, more especially oleyl.

In some embodiments, x and y are independently selected from 1 to 10, especially 2 to 9, 2 to 8, 2 to 7, 2 to 6 or 2 to 5. In some embodiments, x+y is an integer from 2 to 30, especially 2, 5, 8, 10, 15 or 30.

The polyethoxylated alkyl amine may comprise more than one compound where there are variations in the length of the carbon chain in the R group or the number of ethoxylate groups in the ethoxyl chain.

In some embodiments, the polyethoxylated alkyl amine is a compound where R is n-octadec-9-enyl and x and y are both 1 (ethoxylated oleyl amine, E-18-2), R is n-octadec-9-enyl and x+y is 5 (ethoxylated oleyl amine, E-18-5), R is n-octadec-9-enyl and x+y=8 (ethoxylated oleyl amine, E-18-8), R is n-octadec-9-enyl and x+y=10 (ethoxylated oleyl amine, E-18-10), R is n-octadec-9-enyl and x+y=15 (ethoxylated oleyl amine, E-18-15) R is n-octadecyl and x and y are both 1 (ethoxylated stearyl amine, E-18-2), R is n-octadecyl and x+y is 5 (ethoxylated stearyl amine, E-18-5), R is n-octadecyl and x+y=8 (ethoxylated stearyl amine, E-18-8), R is n-octadecyl and x+y=10 (ethoxylated stearyl amine, E-18-10), R is n-octadecyl and x+y=15 (ethoxylated stearyl amine, E-18-15) or mixtures thereof. Suitable polyethoxylated amines are sold under the trade name Teric™ 16M2 and Ethomeen™ O/12LC.

The anionic C₁₀-C₁₆ alkylbenzene sulfonate may be a compound having the formula:

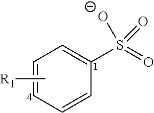

wherein R₁ is a C₁₀-C₁₆ linear or branched alkyl group. The R₁ group may be attached to the 2, 3 or 4 position of the benzene ring, especially the 4-position. Suitable C₁₀ to C₁₆ alkyl groups include, but are not limited to, decyl, undecyl, dodecyl, tridecyl, tetradecyl, pentadecyl, hexadecyl, 2-methylnonyl, 3-methylnonyl, 4-methylnonyl, 2-ethyloctyl, 3-ethyloctyl, 2-methylundecyl, 3-methylundecyl, 4-methylundecyl, 5-methylundecyl, 2-ethyldecyl, 3-ethyldecyl, 4-ethyldecyl, 5-ethyldecyl, 2-propylnonyl, 3-propylnonyl, 4-propylnonyl, 2-butyloctyl, 3-butyloctyl, 4-butyloctyl, 2-pentylheptyl, 3-pentylheptyl, 4-pentylheptyl, and the like. The R₁ group may be attached to the benzene ring at any carbon along the chain of the alkyl group. In some embodiments, R₁ is a dodecyl group, especially a dodecyl group attached in the 4-position of the benzene ring. The dodecyl group may be attached to the benzene ring at the alkyl C1, C2, C3, C4, C5 or C6 carbon atom, especially the C1 carbon atom. In some embodiments, the anionic C₁₀-C₁₆ alkylbenzene sulfonate is 4-n-dodecylbenzene sulfonate.

In some embodiments, the anionic C₁₀-C₁₆ alkylbenzene sulfonate is in a composition containing a carrier, such as an alcohol carrier. In a particular embodiment, the anionic C₁₀-C₁₆ alkylbenzene sulfonate may be in a composition with an 2-ethylhexanol carrier. A particularly suitable composition for use in the invention is Nansa™ EVM 70/2E which is 57% C₁₀-C₁₄ alkylbenzene sulfonate in 2-ethylhexanol.

The surfactant system may comprise each component in a ratio of 20:1 to 1:20 nonionic to anionic surfactant, especially 10:1 to 1 to 10 or 5:1 to 1:5. In some embodiments, the nonionic surfactant is present in an amount greater than the anionic surfactant, for example, a ratio of 2:1 to 10:1 nonionic to anionic surfactant, especially 2:1 to 6:1, more especially 3:1 to 5:1, such as 4:1.

The surfactant system may be present in the emulsion composition in the range of 0.01% v/v to 5% v/v, especially 0.01% to 2% or 0.05% to 1%, more especially 0.05 to 0.5% v/v.

In some embodiments, the composition comprises a further surfactant which is quaternary ammonium salt, especially a dimethyl quaternary ammonium salt having the formula:

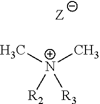

wherein R₂ and R₃ are independently selected from C₈-C₁₈alkyl, C₈-C₁₈alkenyl, phenyl or benzyl and Z is a counterion.

In some embodiments, R₂ and R₃ are independently selected from octyl, decyl, dodecyl, tetradecyl, hexadecyl and octadecyl. In other embodiments, R₂ is selected from phenyl or benzyl and R₃ is selected from octyl, decyl, dodecyl, tetradecyl, hexadecyl and octadecyl.

Suitable counterions include chloride, bromide, iodide, fluoride or salts of organic acids such as acetic, propionic, butyric, tartaric, maleic, hydroxymaleic, fumaric, maleic, citric, lactic, mucic, gluconic, benzoic, succinic, oxalic, phenylacetic, methanesulphonic, toluenesulphonic, benezenesulphonic, salicyclic, sulphanilic, aspartic, glutamic, edetic, stearic, palmitic, oleic, lauric, pantothenic, tannic, ascorbic and valeric acids, especially chloride, bromide or iodide, more especially chloride.

In particular embodiments, the quaternary ammonium salt is octyl, decyl, dodecyl, tetradecyl, hexadecyl or octadecyl benzylalkonium chloride or didecyldimethylammonium chloride (DDAC).

The quaternary ammonium salt may be present in the emulsion composition in an amount of 0.1% v/v to 5% v/v, especially 0.1% v/v to 3% v/v or 0.5% v/v to 2% v/v of the emulsion composition.

The emulsion composition may also include other optional components such as corrosion inhibitors, colouring agents such as dyes or pigments, for example, a blue dye to indicate that the wood has been treated, water repellents such as waxes, resins, fire retardants, UV stabilisers, adjuvants, algicides or mixtures thereof. The emulsion composition may also include penetration enhancers that enhance the penetration of the preservative into the wood. Suitable penetration enhancers include low foaming ethoxylate surfactants such as Tanemul® WT 100, or amine oxides such as trialkylamine oxides, alkylcyclicamine oxides, dialkylpiperazine-di-N-amine oxides, alkyl di(ethoxylated oxyalkyl)amine oxides, dialkylbenzylamine oxides, fatty acyl dimethylaminopropylamine oxides, diamine oxides, triamine oxides or mixtures thereof. Examples of such amine oxides include decyl dimethyl amine oxide, lauryl dimethyl amine oxide, isoalkyl dimethylamine oxide, myristyl dimethyl amine oxide, cetyl dimethyl amine oxide, stearyl dimethylamine oxide, octyl dimethyl amine oxide and N-alkyl(C12-C16)-N,N-dimethylamine oxide. Furthermore, the emulsion composition may also include one or more uptake inhibitors. Uptake inhibitors may be particularly useful in the composition if the wood being treated is infected with a fungal infection such as sapstain, which results in uncontrolled and excessive uptake of the preservative composition. Suitable uptake inhibitors include thixotropes, matting agents, pigment particles and other particulates having an average particle size of between 0.8 and 100

The compositions of the invention may be prepared by conventional means for preparing emulsions. Typically, the wood preserving compound is added to the liquid phase in which it is soluble. For example, the water soluble wood preservative compounds are solubilised in the hydrophilic phase and oil soluble wood preservative compounds are solubilised in the hydrophobic phase.

The surfactant system comprising the non-ionic polyethoxylated alkyl amine and the anionic C₁₀-C₁₆alkyl benzene sulfonate is prepared by mixing the two surfactants together in the required ratio. The surfactant system is then added to the hydrophobic phase.

The hydrophobic and hydrophilic phases are then mixed together using high shear mixing for the required time. The high shear mixing may be any high shear mixing that is known in the art. High shear mixing may be continued for a time suitable to form an emulsion, for example, 10 seconds to 10 minutes, especially 10 seconds to 5 minutes, 10 seconds to 2 minutes, 10 seconds to 1 minute, 10 seconds to 50 seconds, 10 seconds to 40 seconds, 10 seconds to 30 seconds or 10 seconds to 20 seconds. Care should be taken that mixing does not result in the composition forming a “mayonnaise” type emulsion.

The resulting emulsion composition is then used in methods of treating wood.

In another aspect of the present invention there is provided a method of treating wood comprising the steps of:

(i) providing wood for treatment; and

(ii) contacting the wood with a composition of the invention.

As used herein “wood” refers to natural wood and timber produced from that wood, for example by milling. The term “wood” also encompasses engineered wood products. In particular embodiments, the wood to be treated is timber. Suitable timber for treating with the methods of the present invention include frames and trusses used in buildings, fencing, trellises, gazebos, outdoor furniture, flooring timber, utility poles and the like. In some embodiments, the wood is sapwood. In other embodiments, the wood is heartwood. The wood to be treated include softwoods and hardwoods. Softwoods such as Araucaria cunninghamii, Pinus radiata, Southern yellow pine species, Pinus elliottii and Pinus sylvestris, are typically used in house frames and trusses. Engineered wood products include wood composite materials made of wood fibres, wood particles, wood veneer, wood strands or mixtures thereof. Example of engineered wood products are plywood, laminated veneer lumber, oriented strand board, particle board and medium density fibre board.

The wood may be contacted with the composition of the invention by any means suitable to allow uptake and penetration of the composition into the wood being treated. For example in some embodiments, the wood is contacted with the composition by dipping (individual piece or strapped packs), spraying, rolling, misting or brushing. In other embodiments, the wood is contacted with the composition in a vacuum pressure process.

For example, the wood may be typically contacted with the composition by dipping (individual piece or strapped packs), spraying, rolling, misting or brushing for at least about 15 to 90 seconds, for example 20 to 60 seconds. Some timber species may require a longer dip time to achieve adequate penetration and retention of the preservative compound. The contact is then followed by draining of any excess preservative from the wood for 5 to 20 minutes, especially about 10 minutes. For spraying, rolling, misting or brushing a specific uptake of composition should be targeted, such as 5 to 20 L/m³ or 10 to 20 L/m³ to achieve similar penetration and retention as found with dipping.

In one embodiment, the wood is contacted with the composition by dipping. Dipping can be of individual pieces of wood or strapped packs of wood. This method may be particularly advantageous with strapped packs where acceptable coverage of the wood pieces in the internal part of the pack is difficult to achieve by other methods such as spraying. Dipping of strapped packs can achieve full coverage of the wood pieces in the pack, even the internal wood pieces, if the strapped pack is dipped deep enough in the immersion or dipping bath such that a hydrostatic head pressure of at least 5 kPa is exerted at the top of the pack. The required hydrostatic head pressure will depend on the strap tension of the pack. The higher the strap tension, the higher the hydrostatic head pressure required to obtain full coverage of the internal wood pieces in the strapped pack. The hydrostatic head pressure may be between 5 and 20 kPa, for example, 6 kPa, 7.5 kPa, 10 kPa, 12 kPa, 15 kPa or 20 kPa, especially at least 10 kPa.

The uptake of the composition is important to achieve a level of preservative required to achieve the results required, for example, protection against termite attack. The loading of the preservative in the timber is referred to in % mass/mass which is a percentage indicating mass of preservative in a given mass of wood. In one embodiment where the preservative is bifenthrin, the toxic threshold for termiticidal activity is 0.0004 to 0.02% mass/mass and for permethrin the uptake must provide at least 0.02% mass/mass permethrin to meet Australian Standards (AS1604).

The timber may be treated as individual pieces or in a timber pack (full pack) where a number of timber pieces are tightly strapped together ready for transport.

In embodiments where the wood is contacted with the composition by dipping (individual piece or strapped packs), spraying, rolling, misting or brushing, the method is suitable for obtaining superficial or envelope treatment of the wood.

As used herein the term “envelope” refers to where treated wood has absorbed the composition radially, tangentially and/or longitudinally to a depth from the surface of the wood. Controlled envelope formation refers to where the composition is absorbed into the wood substantially evenly in the radial and tangential direction. In some embodiments, the depth of the envelope may be predicted from the ratio of oil and water in the emulsion. In some embodiments, the composition may be absorbed rapidly on a radially cut face and less rapidly on a tangentially cut face resulting in an envelope of uneven depth. The depth of the envelope achieved may also be affected by the quality and/or type of wood being treated.

In other embodiments, the wood is subject to a vacuum pressure process in the presence of the emulsion composition. Vacuum pressure treatment is known in the art and may involve the use of a Bethell, Lowry or Reuping process or Vac-Vac process as used with the light organic solvent preservative (LOSP) processes.

Traditionally a vacuum pressure water borne treatment has a pressure range of −90 kPa to +1500 kPa. For example, a Bethell process for water borne preservatives may have a process involving:

| Load wood for treatment | | |
|---|---|---|
| Initial vacuum | −1 to −90 | kPa |
| Flood with preservative whilst | −1 to −90 | kPa |
| maintaining vacuum | | |
| Hydraulic pressure | 10 to 1400 | kPa |
| Release pressure and drain preservative | 0 | kPa |
| Final vacuum | −90 | kPa |
| Final drain | 0 | kPa |

The time of the initial vacuum treatment can vary from 1 minute to several hours. The level of vacuum applied can vary and this can effect uptake, for example, less vacuum lower uptake. The duration of the hydraulic pressure step can vary from 1 minute to several hours. The level of hydraulic pressure can vary depending on the wood species permeability. The hydraulic pressure maybe also be ramped down, for example, by 100 kPa/min to maximise removal of liquid from the wood as pressure is applied. The duration of the final vacuum can vary from 1 min to several hours. Final vacuum tends to be maximum achievable to maximise preservative recovery and surface dryness of the treated wood. The duration of the various steps depends on the species being treated, how the wood has been preconditioned, for example the drying method used to pre-dry the wood, the initial moisture content of wood, the heartwood content and required penetration in the heartwood and the retention of preservative required. Heartwood in much more difficult to treat than sapwood

A typical water borne Lowry process (single pressure cycle Lowry process) includes the following steps:

| Load wood for treatment | | |
|---|---|---|
| Flood without vacuum | 0 | kPa |
| Hydraulic pressure | 10 to 1400 | kPa |
| Release Pressure and drain preservative | 0 | kPa |
| Final vacuum | −90 | kPa |
| Final drain | 0 | kPa |

As with Bethell process, the level of applied hydraulic pressure and duration of pressure applied varies depending on species of wood to be treated, how the wood has been preconditioned, for example the drying method used to pre-dry the wood, the initial moisture content of wood, the heartwood content. The duration of the final vacuum is again varied to maximise preservative recovery and dryness of treated wood.

A typical water borne Reuping process includes the steps of:

| Load wood for treatment | | |
|---|---|---|
| Apply pneumatic pressure | 1 to 500 | kPa |
| Flood maintaining pneumatic pressure | ″ | |
| Apply hydraulic pressure | up to 1400 | kPa |
| Release pressure and drain | 0 | kPa |
| Final vacuum | −90 | kPa |
| Final drain | 0 | kPa |

The duration and level of initial pneumatic pressure and hydraulic pressure can be varied depending on the species of wood to be treated. The hydraulic pressure applied must exceed the initially applied pneumatic pressure.

A variation on the water borne Lowry process uses pulsation or alternating pressure (multiple pressure cycle Lowry process). For example this process has the steps of:

| | |
|---|---|
| Load wood for treatment | |
| Flood the cylinder | |
| Apply hydraulic pressure | up to 1400 kPa and hold for up to 1 minute |
| Release pressure | 0 kPa for up to 1 minute |

Re-apply hydraulic pressure for of 2 to 50 cycles then drain cylinder

| | |
|---|---|
| Final vacuum | −90 kPa for 10 to 30 minutes |

The uptake of preservative reduces from Bethell process to Lowry process to Reuping process because the level of pressure initially applied affects the amount of air removed from the wood. In the Bethell process vacuum removes more air than in a Lowry process where no vacuum is applied. Uptake of preservative is further reduced with a Reuping process as the initial step is applied air pressure. However, penetration of the preservative into the wood is not affected provided that a sufficient level of pressure is applied for suitable time during the wood treatment.

Typical uptakes of water based preservative composition for pine species with polar (water borne) preservatives are:

| | | |
|---|---|---|
| Bethell | >450 | L/m³ |
| Lowry | 300 to 350 | L/m³ |
| Reuping | 200 to 250 | L/m³ |

The Bethell, Lowry and Reuping processes described above may also be used with preservatives that are in non-polar solvents. However, the pressures used in these processes are significantly reduced when non-polar solvents are used.

For example the Bethell process may have an initial vacuum of only −5 to 10 kPa held for 1 to 5 minutes followed by hydraulic pressure of <100 kPa held for 1 to 5 minutes then final vacuum of −90 kPa held for 10 to 15 minutes. Uptake of the preservative composition is much lower, for example, less than 150 L/m³.

Similarly a Lowry process using a preservative in non-polar solvent involves flooding then hydraulic pressure as low as 10 to 20 kPa up to 150 kPa. This is followed by draining of the solvent then vacuum of −90 kPa held for a time such as 10 to 15 minutes. Again uptake of the preservative composition is lower than with a water borne process, for example, 30 to 80 L/m³.

Low pressure Reuping processes may also be used with preservative compositions in non-polar solvents. For example, the initial pneumatic pressure may be as low as 10 kPa followed by hydraulic pressure of 30 to 150 kPa. After draining the preservative composition, a final vacuum of −90 kPa may be held for about 15 minutes. Uptake of the preservative composition using this process is in the range of 25 to 60 L/m³.

For non-polar solvents a Vac-Vac process is also sometimes used. This process involves drawing a low initial vacuum of about −10 kPa then flooding and soaking of the wood to be treated occurs followed by release of the vacuum. The preservative composition is then drained and a final vacuum drawn. With this process uptake of the preservative composition is in the range of 25 to 60 L/m³.

The composition of the present invention may be used in any of the Bethell, single pressure cycle Lowry, multiple pressure cycle Lowry, Reuping or Vac-Vac or variations of these processes known by those skilled in the art of wood preservation where pressure applied may be between −90 and +1500 kPa. The treatment may include loading the wood, followed by application of initial vacuum or initial pressure or the wood may be treated directly with no initial vacuum or pressure treatment. The wood is subsequently contacted or flooded with the preservative composition of the invention. Once flooded with the preservative composition, vacuum or pressure may be applied. Once the pressure or vacuum is released, the preservative composition may be drained and a final vacuum applied.

In some embodiments, applied pressure is in the range of 0 kPa to 300 kPa. In some embodiments, the process used for the treatment of wood with the composition of the invention is a low pressure Lowry process.

The methods of the present invention in which a vacuum pressure process is used, the uptake of the preservative composition is between 20 to 300 L/m³, especially 25 to 100 L/m³.

Advantageously, the methods of the present invention are able to reduce the amount of non-polar solvent (hydrophobic phase) used in the process and increase the amount of water or hydrophilic phase used, without substantially increasing the moisture content of the wood. By “without substantially increasing moisture content of the wood” refers to an increase in moisture of less than 10%, especially less than 8% or 6% and especially less than 4%.

Typically water based treatments have uptakes of greater than 100 L/m³, especially greater than 300 L/m³ to achieve full sapwood penetration. The moisture content increase that occurs with this type of treatment may cause swelling of the wood which would be unacceptable. In contrast, those processes using 100% non-polar solvent (“dry after” treatment) the moisture content does not increase.

With the emulsion compositions of the present invention, a proportion of the non-polar solvent may be replaced with polar phase, without substantially increasing the moisture content of the wood. This results in minimal swelling of the wood compared to water borne treatments. The effect of water content in the composition of the invention on the moisture content of the wood is shown in the following table:

| | Initial | Water | | | | | | | | | | | |
|---|---|---|---|---|---|---|---|---|---|---|---|---|---|
| OD | Moisture | in | | | | | | | | | | | |
| Density | Content | wood | Uptake | % water in emulsion | | | | | Final moisture content after | | | | |
| kg/m³ | % | litres | 1/m3 | 20 | 30 | 40 | 50 | 60 | treatment % | | | | |
| 500 | 12 | 60 | 30 | 6.0 | 9.0 | 12.0 | 15.0 | 18.0 | 13.2 | 18.0 | 14.4 | 15.0 | 15.6 |
| 500 | 12 | 60 | 35 | 7.0 | 10.5 | 14.0 | 17.5 | 21.0 | 13.4 | 13.8 | 14.8 | 15.5 | 16.2 |
| 500 | 12 | 60 | 40 | 8.0 | 12.0 | 16.0 | 20.0 | 24.0 | 13.6 | 14.1 | 15.2 | 16.0 | 16.8 |
| 500 | 12 | 60 | 45 | 9.0 | 13.5 | 18.0 | 22.5 | 27.0 | 13.8 | 14.4 | 15.6 | 16.5 | 17.4 |
| 500 | 12 | 60 | 50 | 10.0 | 15.0 | 20.0 | 25.0 | 30.0 | 14.0 | 14.7 | 16.0 | 17.0 | 18.0 |

As can be seen from the table, a maximum moisture increase was 6% for a composition having 60% water and 20% hydrophobic phase with an uptake of 50 L/m³.

There are a number of advantages of the vacuum pressure process. In particular, replacing the low odour solvent with the emulsion of the invention significantly reduces cost without affecting efficacy of the treatment and with minimal effects on moisture treatment content and swelling of the wood. Furthermore, there are less volatile organic compounds present and therefore less “greenhouse gas” emissions and reduced odour.

Advantageously, once the hydrophobic phase is incorporated into the emulsion, any flammability or combustibility associated with that phase is diminished or removed.

In another aspect of the invention there is provided wood or engineered wood products treated by the method outlined above.

In order that the nature of the present invention be more clearly understood and put into practical effect, specific embodiments will now be described by way of the following non-limiting examples.

### EXAMPLES

### Example 1

### Emulsion Stability

Emulsions were prepared with varying ratios of non-polar white spirits and polar water phases.

A surfactant system comprising two surfactants, non-ionic polyethoxylated oleylamine (Huntsman Teric 16M2) and anionic 57% linear dodecyl benzene sulfonate in 2-ethylhexanol (Nansa EVM 70/2E) was prepared by mixing the non-ionic surfactant and anionic surfactant in a ratio of 4:1.

The surfactant system was added to the white spirits in an amount that provides varying concentrations, 0.1, 0.3, 0.45 and 1.0 v/v of the total emulsion composition. The required volume of water was added to provide the required ratio of white spirit to water, 20:80, 40:60, 50:50, 60:40, 70:30 and 80:20. The composition was mixed by high shear mixing for 15 seconds.

The emulsion stability was assessed by monitoring the time taken for the two phases to separate. The emulsion was considered stable if there was no separation in 2 hours. If separation of the phases occurs within 2 hours, the emulsion was classed as unstable.

The results are shown in Table 1:

TABLE 1

| Carrier | | | | | |
|---|---|---|---|---|---|
| % White | | % v/v mixed Surfactants | | | |
| Spirits | % Water | 0.10 | 0.3 | 0.45 | 1.0 |
| 20 | 80 | Stable | Stable | Stable | Stable |
| 40 | 60 | Stable | Stable | Stable | Stable |
| 50 | 50 | Stable | Stable | Stable | Stable |
| 60 | 40 | Unstable | Stable | Stable | Stable |
| 70 | 30 | Unstable | Unstable | Stable | Stable |
| 80 | 20 | Unstable | Unstable | Unstable | Stable |

The emulsions were stable with increasing amounts of polar phase and/or increasing amounts of surfactant systems.

### Example 2

### Emulsion Stability

The method of Example 1 was repeated with the non-ionic and anionic surfactant system at concentrations of 0.1, 0.2, 0.35 and 0.45% v/v. After preparation of the emulsion, benzylalkonium chloride (BAC) was added at a concentration of 1% v/v (1.5 g/L of 150 g/L solution) and the composition was subject to about 1 minute further high shear mixing.

The stability of the emulsions was assessed as for Example 1. The results are shown in Table 2:

TABLE 2

| Carrier | | | | | |
|---|---|---|---|---|---|
| % White | | % surfactant system + 1% v/v BAC | | | |
| Spirits | % Water | 0.10 | 0.2 | 0.35 | 0.45 |
| 20 | 80 | Stable | Stable | Stable | Stable |
| 40 | 60 | Stable | Stable | Stable | Stable |
| 50 | 50 | Stable | Stable | Stable | Stable |
| 60 | 40 | Unstable | Stable | Stable | Stable |
| 70 | 30 | Unstable | Stable | Stable | Stable |
| 80 | 20 | Unstable | Unstable | Unstable | Stable |

The inclusion of BAC improved the stability of the emulsions.

### Example 3

### Emulsion Stability

The method of Example 1 was repeated using High Flash kerosene as the non-polar phase. The stability of the emulsions was assessed and the results are shown in Table 3:

TABLE 3

| Carrier | | | | | |
|---|---|---|---|---|---|
| % High Flash | | % v/v mixed Surfactants | | | |
| Kerosene | % Water | 0.10 | 0.3 | 0.45 | 1.0 |
| 20 | 80 | Stable | Stable | Stable | Stable |
| 40 | 60 | Stable | Stable | Stable | Stable |
| 50 | 50 | Stable | Stable | Stable | Stable |
| 60 | 40 | Unstable | Stable | Stable | Stable |
| 70 | 30 | Unstable | Unstable | Stable | Stable |
| 80 | 20 | Unstable | Unstable | Unstable | Stable |

### Example 4

### Emulsion Stability

The method of Example 2 including BAC was repeated using High Flash kerosene as the non-polar phase. The stability of the emulsions was assessed and the results are shown in Table 4:

TABLE 4

| Carrier | | | | | |
|---|---|---|---|---|---|
| % High Flash | | % surfactant system + 1% v/v BAC | | | |
| Kerosene | % Water | 0.10 | 0.2 | 0.35 | 0.45 |
| 20 | 80 | Stable | Stable | Stable | Stable |
| 40 | 60 | Stable | Stable | Stable | Stable |
| 50 | 50 | Stable | Stable | Stable | Stable |
| 60 | 40 | Unstable | Stable | Stable | Stable |
| 70 | 30 | Unstable | Stable | Stable | Stable |
| 80 | 20 | Unstable | Unstable | Unstable | Stable |

### Example 5

### Emulsion Stability

Emulsions were prepared with water and high flash kerosene at ratios of 60:40 and 40:60. The emulsions were prepared with a surfactant system of polyethoxylated oleylamine (Huntsman Teric 16M2) and 57% liner dodecyl benzene sulfonate in 2-ethylhexanol (Nansa EVM 70/2E) in a ration of 4:1. The surfactant system was added to the high flash kerosene which contained copper naphthenate at a copper concentration of 20 g/L of the high flash kerosene. The surfactant system was added to the high flash kerosene/copper naphthenate composition in amounts to provide concentrations of surfactant system of 0.2, 0.4 and 0.6% v/v of the total emulsion composition. The water was added and the composition mixed with high shear mixing for 15 seconds. The stability of the emulsions was assessed as described in Example 1. The results are shown in Table 5:

TABLE 5

Carrier

| | |
|---|---|
| % CuNap | % Mixed Surfactants |

| in HFK | % Water | 0.2 | 0.4 | 0.6 |
|---|---|---|---|---|
| 40 | 60 | Unstable | Unstable | Stable |
| 60 | 40 | Unstable | Unstable | Stable |

The addition of wood preserving active ingredient does not affect emulsion stability.

### Example 6

### Permeability of Emulsions in Wood

A simple methodology was developed to assess permeability of the emulsions into wood.

Emulsions were prepared with varying ratios of white spirits and water, 80:20, 60:40, 50:50, 40:60, 30:70, 20:80, containing 0.1% v/v surfactant system (Teric 16M2:Nansa EVM 70/2E 4:1) for all emulsions except for the white spirit:water 20:80 which had 1% surfactant system.

90×45×300 mm lengths of timber (Pinus elliottii) were used. At regular intervals along the piece length 0.25 mL of each emulsion was dropped onto the tangential face with penetration in the radial direction.

The time taken for 0.25 mL of the emulsion to penetrate into the timber was assessed. The results are shown in Table 6:

TABLE 6

| | % White | % Mixed | 0.25 mL applied to | |
|---|---|---|---|---|
| % Water | Spirits | Surfactant | Surface of wood | |
| 80 | 20 | 0.10 | 120 | sec |
| 60 | 40 | 0.10 | 360 | sec |
| 50 | 50 | 0.10 | 135 | sec |
| 40 | 60 | 0.20 | 60 | sec |
| 30 | 70 | 0.20 | 40 | sec |
| 20 | 80 | 1 | 30 | sec |

Increasing non-polar solvent concentrations increases the rate of permeability.

### Example 7

The method of Example 6 was repeated with emulsions further comprising 1% of a 150 g/L BAC solution. The results are shown in Table 7:

TABLE 7

| % White | | % Mixed | % 150 g/L | 0.25 mL applied to |
|---|---|---|---|---|
| Spirits | % Water | Surfactant | BAC | Surface of wood |
| 80 | 20 | 0.10 | 1 | 55 sec |
| 60 | 40 | 0.10 | 1 | 45 sec |
| 50 | 50 | 0.10 | 1 | 35 sec |
| 40 | 60 | 0.20 | 1 | 30 sec |
| 30 | 70 | 0.20 | 1 | 30 sec |
| 20 | 80 | 1 | 1 | 30 sec |

The presence of BAC dramatically reduced the time taken for the emulsion to be absorbed, demonstrating improved permeability.

### Example 8

The method of Example 6 was repeated with high flash kerosene as the non-polar phase. The results are shown in Table 8:

TABLE 8

| | | % Mixed | 0.25 mL applied to | |
|---|---|---|---|---|
| % HFK | % Water | Surfactant | Surface of wood | |
| 20 | 80 | 0.10 | 135 | sec |
| 40 | 60 | 0.10 | 1140 | sec |
| 50 | 50 | 0.10 | 840 | sec |
| 60 | 40 | 0.20 | 280 | sec |
| 70 | 30 | 0.20 | 190 | sec |
| 80 | 20 | 0.45 | 60 | sec |

### Example 9

The method of Example 7 was repeated with high flash kerosene as the non-polar phase. The results are shown in Table 9.

TABLE 9

| | | % Mixed | % 150 g/L | 0.25 mL applied to |
|---|---|---|---|---|
| % HFK | % Water | Surfactant | BAC | Surface of wood |
| 20 | 80 | 0.10 | 1 | 70 |
| 40 | 60 | 0.10 | 1 | 300 |
| 50 | 50 | 0.10 | 1 | 285 |
| 60 | 40 | 0.20 | 1 | 180 |
| 70 | 30 | 0.20 | 1 | 100 |
| 80 | 20 | 0.45 | 1 | 60 |

### Example 10

An emulsion with a ratio of 80:20 white spirit:water containing a surfactant system of Teric 16M2:Nansa EVM 70/2E, 4:1 at a concentration of 0.4% v/v was prepared.

End sealed 425 mm×140 mm×35 mm samples of hoop pine and slash pine sapwood were treated using a low pressure Lowry process as set out in Table 10:

TABLE 10

| Sequence step | Pressure (kPa) | Time (sec) |
|---|---|---|
| Flood | 0 | 30 |
| Pressure | 80 | 300 |
| Drain | 0 | 30 |
| Final Vac | −90 | 360 |

The average uptake of emulsion composition is shown in Table 11:

TABLE 11

| | | Emulsion | Uptake | Uptake | |
|---|---|---|---|---|---|
| | | Uptake | solvent | water | Sapwood |
| Species | Size | (L/m³) | (L/m³) | (L/m³) | Penetration |
| Hoop | 140 × 35 | 62 | 49.6 | 12.4 | 100 |
| Slash | 140 × 35 | 48.4 | 38.7 | 9.7 | 100 |

In all cases 100% sapwood penetration was achieved.

The initial moisture content of the timber treated was 12%, and the treatment gave an average moisture increase as shown in Table 12:

TABLE 12

| | | Uptake water | Moisture content |
|---|---|---|---|
| Species | Size | (L/m³) | increase % |
| Hoop | 140 × 35 | 12.4 | 1.8 |
| Slash | 140 × 35 | 9.7 | 1.7 |

The moisture increase was not enough to have a detrimental impact on wood strength.

### Example 11

The method of Example 10 was repeated with slash pine samples and with a different low pressure Lowry process as set out in Table 13:

TABLE 13

| Sequence step | Pressure (kPa) | Time (sec) |
|---|---|---|
| Flood | 0 | 30 |
| Pressure | 50 | 300 |
| Drain | 0 | 30 |
| Final Vac | −90 | 360 |

The average uptake of emulsion composition is shown in Table 14:

TABLE 14

| | | Emulsion | Uptake | Uptake | |
|---|---|---|---|---|---|
| | | Uptake | solvent | water | Sapwood |
| Species | Size | (L/m³) | (L/m³) | (L/m³) | Penetration |
| Slash | 140 × 35 | 40.1 | 32.1 | 8.0 | 100 |

In all samples 100% sapwood penetration was achieved.

The initial moisture content of the timber treated was 12%, and the treatment gave an average moisture content increase of 1.4% as shown in Table 15:

TABLE 15

| | | Uptake water | Moisture content |
|---|---|---|---|
| Species | Size | (L/m³) | increase % |
| Slash | 140 × 35 | 8.0 | 1.4 |

The moisture increase was not enough to have a detrimental impact on wood strength.

### Example 12

An emulsion with a ratio of 60:40 white spirits:water containing a surfactant system of Teric 16M2:Nansa EVM70/2E in a 4:1 ratio at a concentration of 0.4% v/v was prepared.

End sealed 425 mm lengths of slash pine having dimensions:
70×35 mm
90×45 mm
140×35 mm
   were used in the treatment.

Treatment was carried out using a low pressure Lowry process as set out in Table 16.

TABLE 16

| Sequence step | Pressure (kPa) | Time (sec) |
|---|---|---|
| Flood | 0 | 30 |
| Pressure | 100 | 300 |
| Drain | 0 | 30 |
| Final Vac | −90 | 360 |

The average uptake of emulsion composition for the 70×35 mm samples is shown in Table 17:

TABLE 17

| | | Emulsion | Uptake | Uptake | |
|---|---|---|---|---|---|
| | | Uptake | solvent | water | Sapwood |
| Species | Size | (L/m³) | (L/m³) | (L/m³) | Penetration |
| Slash | 70 × 35 | 36.9 | 21.8 | 14.8 | 100 |

In all samples 100% sapwood penetration was achieved.

The initial moisture content of the timber was 12%, and the treatment gave an average moisture content increase of 2.6% as shown in Table 18:

TABLE 18

| | | Uptake water | Moisture content |
|---|---|---|---|
| Species | Size | (L/m³) | increase % |
| Slash | 140 × 35 | 14.8 | 2.6 |

The moisture increase was not enough to have a detrimental impact on wood strength.

### Example 13

The method of Example 12 was repeated with a different low pressure Lowry process as set out in Table 19:

TABLE 19

| Sequence step | Pressure (kPa) | Time (sec) |
|---|---|---|
| Flood | 0 | 30 |
| Pressure | 100 | 420 |
| Drain | 0 | 30 |
| Final Vac | −90 | 360 |

The average uptake of emulsion composition is shown in Table 20:

TABLE 20

| | | Emulsion | Uptake | Uptake | |
|---|---|---|---|---|---|
| | | Uptake | solvent | water | Sapwood |
| Species | Size | (L/m³) | (L/m³) | (L/m³) | Penetration |
| Slash | 90 × 45 | 56.7 | 34.0 | 22.7 | 100 |
| Slash | 140 × 35 | 37.4 | 22.5 | 15.0 | 100 |

In all samples 100% sapwood penetration was achieved.

The initial moisture content of the timber treated was 12%, and the treatment gave an average moisture content increase as shown in Table 21:

TABLE 21

| | | Uptake water | Moisture content |
|---|---|---|---|
| Species | Size | (L/m³) | increase % |
| Slash | 90 × 45 | 22.7 | 4.1 |
| Slash | 140 × 35 | 15.0 | 2.7 |

### Example 14

An emulsion with a 60:40 ratio of white spirits to water was prepared with zinc octanoate as a penetration marker and a surfactant system containing polyethoxylated oleylamine (Huntsman Teric 16M2) and 57% dodecyl benzene sulfonate in 2-ethylhexanol (Nansa EVM 70/2E) in a 4:1 ratio in an amount of 0.5% v/v of the emulsion composition.

Timber treated was sapwood of Pinus radiata with the dimensions 425 mm×70 mm×35 mm. The timber samples were end sealed.

Two low pressure Lowry processes were used and the uptake and penetration of the composition was assessed using spot testing with 1-(2-pyridylazo)-2-naphthol (PAN) indicator.

The two low pressure Lowry process conditions are shown in Table 22:

TABLE 22

| | Treatment 1 | | Treatment 2 | |
|---|---|---|---|---|
| Sequence Step | Pressure (kPa) | Time (s) | Pressure (kPa) | Time (s) |
| Flood | 0 | 5 | 0 | 5 |
| Pressure | 80 | 120 | 40 | 120 |
| Drain | 0 | 60 | 0 | 60 |
| Vacuum | −90 | 600 | −90 | 600 |

The uptake of the emulsion composition is shown in Table 23:

TABLE 23

| | Treatment 1 | Treatment 2 |
|---|---|---|
| Radiata Pine | (L/m³) | (L/m³) |
| 1 | 70.1 | 42.6 |
| 2 | 66.6 | 44.4 |
| 3 | 49.0 | 36.0 |
| 4 | 46.2 | 35.7 |
| 5 | 112.5 | 59.1 |
| 6 | 107.0 | 73.0 |
| Average | 75.2 | 48.5 |
| StdDev | 28.4 | 14.7 |
| % CV | 37.7 | 30.4 |

In all samples 100% penetration of the sapwood was achieved.

### Example 15

An emulsion with 80:20 white spirits to water was prepared with copper naphthenate as a penetration marker and a surfactant system containing polyethoxylated oleylamine (Huntsman Teric 16M2) and 57% dodecyl benzene sulfonate in 2-ehtylhexanol (Nansa EVM 70/2E) in a 4:1 ratio in an amount of 0.5% v/v of the emulsion composition.

Two timber species, slash pine (Pinus elliottii) 400 mm×90 mm×45 mm and hoop pine (Araucania cunninghamii) 400 mm×190 mm×40 mm, were end sealed and treated with the low pressure Lowry process shown in Table 24:

TABLE 24

| Sequence Step | Pressure (kPa) | Time (s) |
|---|---|---|
| Flood | 0 | 5 |
| Pressure | 40 | 90 |
| Drain | 0 | 60 |
| Vacuum | −90 | 600 |

The average uptake of emulsion for the slash pine was 45.7 L/m³ and for the hoop pine 52.2 L/m³. In all samples, spot tests for penetration showed 100% sapwood penetration.

1. A composition for treating wood comprising a carrier and at least one wood preserving compound; said carrier being an emulsion comprising:
a) a hydrophobic phase;
b) a hydrophilic phase; and
c) a surfactant system comprising:
i) a non-ionic polyethoxylated alkyl amine and
ii) an anionic C₁₀-C₁₄ alkyl benzene sulfonate.

2. A composition according to claim 1 further comprising a quaternary ammonium salt.

3. A composition according to claim 1 wherein the ratio of non-ionic polyethoxylated alkylamine to anionic C₁₀-C₁₄ alkylbenzene sulfonate is in the range of 4:0.5 to 4:1.5.

4. A composition according to claim 3 wherein the ratio of non-ionic polyethoxylated alkylamine to anionic C₁₀-C₁₄ alkylbenzene sulfonate is about 4:1.

5. A composition according to claim 1, wherein the surfactant system is present in the carrier in an amount of 0.05% to 2% v/v.

6. A composition according to claim 2 wherein the quaternary ammonium salt is present in the carrier in an amount of from 0.1% to 5% v/v.

7. A composition according to claim 1, wherein the non-ionic polyethoxylated alkylamine is ethoxylated oleylamine.

8. A composition according to claim 7, wherein the anionic C₁₀-C₁₄ alkyl benzene sulfonate is linear dodecylbenzene sulfonate.

9. A composition according to claim 2 wherein the quaternary ammonium salt is a benzylalkonium chloride or didecyldimethylammonium chloride.

10. A composition according to claim 1, wherein the hydrophobic phase is selected from white spirits, mineral spirits, Stoddards solvent, kerosene, turpentines, jet fuel, low flash point hydrocarbons, low flash point bio-solvents, mineral oils, vegetable oils, fish oils, biodiesel, aromatic solvents, low aromatic hydrocarbon solvents, diesel, aromatic oils, paraffin oil, isoparaffin oil, narrow cut kerosene, high flash kerosene and mixtures thereof

11. A composition according to claim 1, wherein the hydrophilic phase is selected from water, monoethylene glycol, polyethylene glycol, hexylene glycol, glycerine, acetone and alcohols.

12. A composition according to claim 1, wherein the wood preserving compound is selected from a fungicide, bactericide and insecticide or mixtures thereof.

13. A composition according to claim 1, wherein the ratio of hydrophobic phase to hydrophilic phase is in the range of 20:80 to 80:20.

14. A composition according to claim 1 further comprising a corrosion inhibitor, a colouring agent, a water repellent, a UV stabilizer, an algicide, a penetration enhancer, an uptake inhibitor or a mixture thereof.

15. A method of treating wood comprising the steps of:
i) providing wood for treatment; and
ii) contacting wood with a composition of claim 1.

16. A method according to claim 15 wherein the wood is contacted with the composition by dipping, spraying, rolling, misting or brushing.

17. A method according to claim 15 wherein the wood is contacted with the composition by a vacuum pressure process.

18. A method according to claim 17 wherein the vacuum pressure process is a Bethell process, a single pressure cycle Lowry process, a multiple pressure cycle Lowry process, a Reuping process or a Vac-Vac process.

19. A method according to claim 18 wherein the vacuum pressure process is a low pressure Lowry process.

20. A method according to claim 17, wherein the pressure applied during the vacuum pressure process is 0 to 300 kPa.

21. A method according to claim 17, wherein the uptake of composition by the wood is in the range of 20 to 300 L/m³.
